(19) United States
(12) Patent Application Publication
(10) Pub. No.: US 2007/0248795 A1
(43) Pub. Date: Oct. 25, 2007

(54) Formed Graphic Applique

(75) Inventors: Michael Hansen, West Bend, WI (US); Robert W. Averkamp, Germantown, WI (US); Michael G. Reindl, West Bend, WI (US)

Correspondence Address: MICHAEL E. TAKEN;Andrus, Sceales, Starke & Sawall, Suite 1100, 100 East Wisconsin Avenue, Milwaukee, WI, 53202, US

(73) Assignee: Serigraph, Inc., West Bend, WI (US)

(21) Appl. No.: 11/750,453

(22) Filed: May 18, 2007

Related U.S. Application Data
(62) Division of application No. 10/868,143, filed on Jun. 15, 2004.
(60) Provisional application No. 60/479,947, filed on Jun. 19, 2003.

(51) Int. Cl. B32B 1/00

(52) U.S. Cl. 428/187

(57) ABSTRACT

An appliqué is formed by a sheet having a printed first area providing a printed graphic, and a deformed second area having a relief profile providing a three dimensional formed graphic bordering the printed graphic.

### CROSS REFERENCE TO RELATED APPLICATION

This application claims the benefit of and priority from provisional U.S. Patent Application No. 60/479,947, filed Jun. 19, 2003, incorporated herein by reference.

### BACKGROUND AND SUMMARY

The invention relates to appliqués and methods for making same, and more particularly to an appliqué having a printed graphic bordered by a three dimensional graphic.

Appliqués having a printed graphic bordered by a three dimensional graphic are known in the prior art. For example, automotive instrument clusters have rings around various dials. The rings may be injection molded, and then attached directly to an instrument cluster appliqué or to the front mask component that protects the dial. The rings may be decorated or undecorated, may be vacuum metallized to give a metallic appearance, may be metal plated to give a metallic appearance, may be painted, and the like. Various attachment methods are known, including heat staking, sonic welding, gluing, and insert molding. Functional rings are also known, particularly in aftermarket applications. These rings may be used to affix a front lens to the dial and/or in the assembly of the dial, for example aftermarket gauges with a functional chrome ring.

The present invention provides a simple and particularly cost-effective improvement for the above noted and other applications, by forming the three dimensional graphic in the appliqué itself.

### BRIEF DESCRIPTION OF THE DRAWING

FIG. 1 is a side view illustrating an initial step in making an appliqué in accordance with the invention.

FIG. 2 is like FIG. 1 and shows a further processing step.

FIG. 3 is like FIG. 2 and shows a further processing step.

FIG. 4 is a front elevation view of the substrate of FIG. 2.

FIG. 5 is a front elevation view of a printed sheet substrate.

FIG. 6 is like FIG. 5 and shows a further processing step.

FIG. 7 is an enlarged view of a portion of FIG. 6.

FIG. 8 is a side view showing a further processing step.

FIG. 9 is like FIG. 8 and shows a further processing step.

FIG. 10 is like FIG. 9 and shows a further processing step.

FIG. 11 is like FIG. 10 and shows an alternate embodiment.

FIG. 12 is an exploded perspective view showing a further embodiment.

FIG. 13 is a side view of a portion of FIG. 12.

FIG. 14 is a perspective view of an appliqué constructed in accordance with the invention.

FIG. 15 is a perspective view partly in section taken along line 15-15 of FIG. 14.

FIG. 16 is a side view of a portion of an appliqué in accordance with the invention and shows a further embodiment.

FIG. 17 is like FIG. 14 and shows an alternate embodiment.

### DETAILED DESCRIPTION

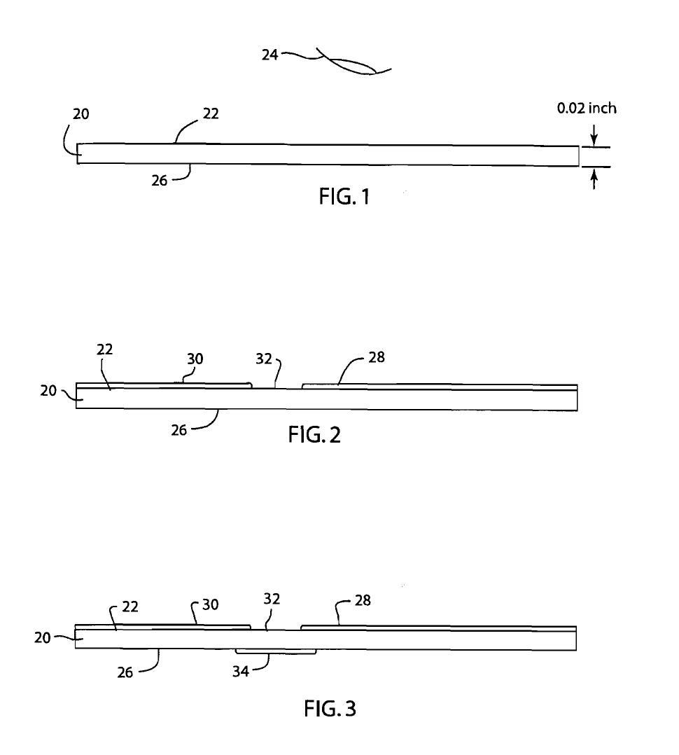

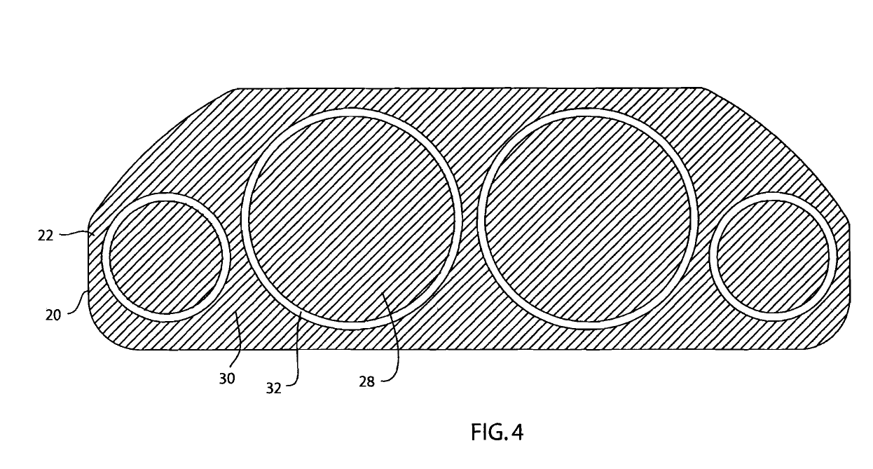

FIG. 1 shows a substrate sheet 20 for forming an appliqué in accordance with the invention. Substrate 20 is a thin flat plastic sheet, preferably polycarbonate, polyester, acrylic, or other materials, with extruded polycarbonate being preferred. The material may be transparent, translucent, or opaque, with transparent being preferred. The thickness of the sheet is in the range from 0.005 inch to 0.06 inch, with 0.02 inch being preferred. The sheet has a first surface 22 facing forwardly toward an observer 24, and an oppositely facing second surface 26 facing rearwardly away from observer 24. First surface 22 is preferably high gloss, and second surface 26 is preferably high gloss or matte. Substrate sheet 20 is printed on either or both of first and second surfaces 22 and 26, preferably by screen printing, though other types of printing may be used including pad printing, offset printing, digital printing, painting, laser etching, and so on. Depending on the printed graphic desired, the surface such as 22 is printed at one or more ink areas such 28, 30, FIG. 2, while other areas such as 32 are left blank with no ink. In a further embodiment, FIG. 3, the other surface such as 26 is printed with ink at area 34 opposite area 32, for example for purposes of tinting or otherwise colorizing or decorating the area of the formed graphic, to be described.

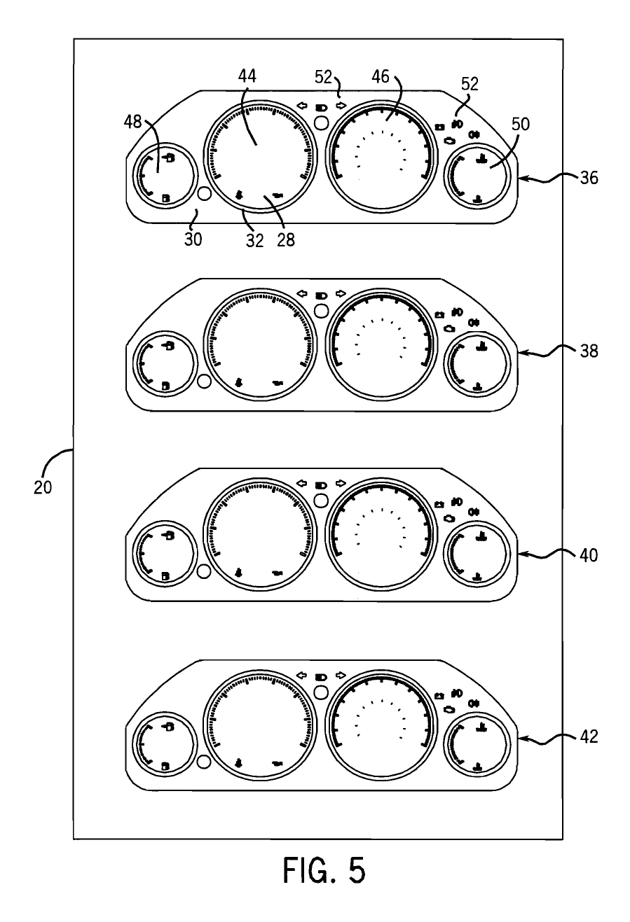

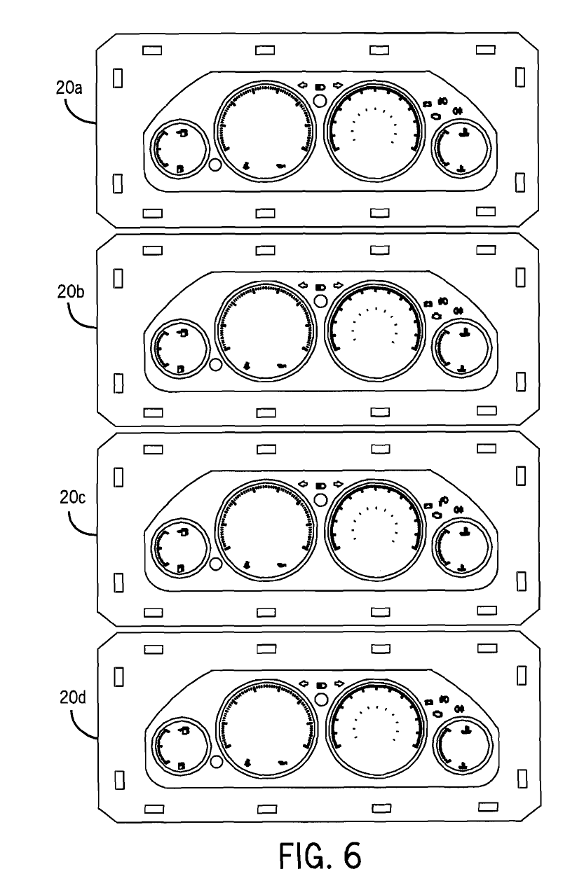

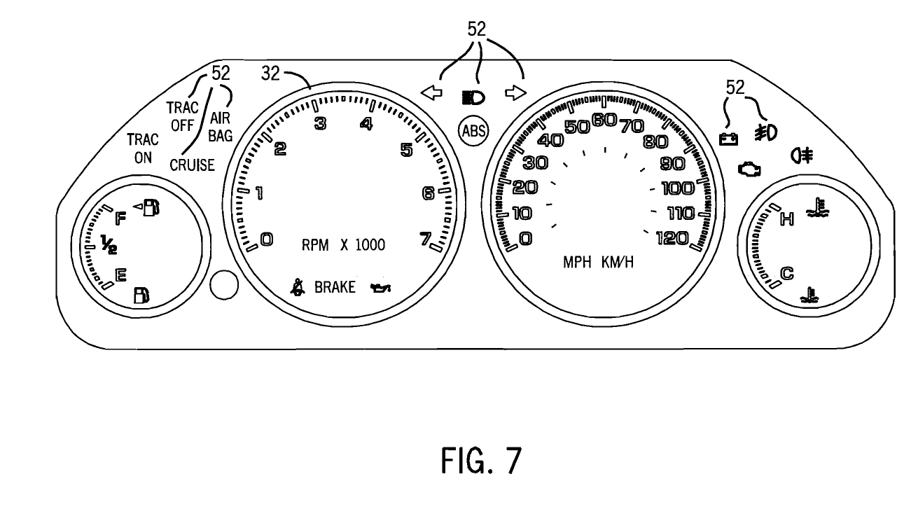

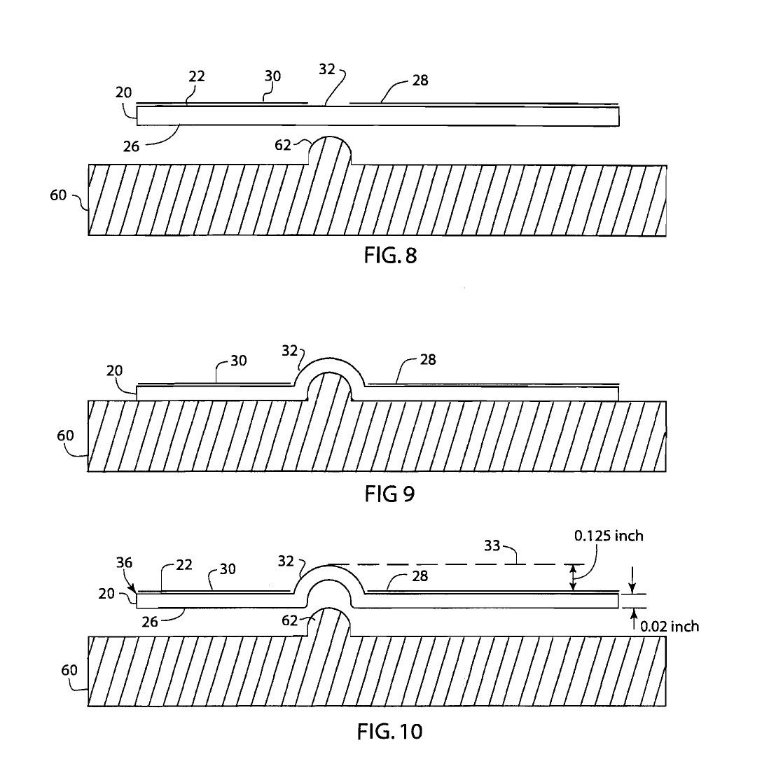

FIG. 4 shows a front or top elevation view from above, i.e. the top side of first surface 22, showing sheet 20 of FIG. 2 schematically illustrating inked areas 28 and 30, and non-inked area 32. As shown in FIG. 5, multiple appliqués, such as a set of four appliqués 36, 38, 40, 42 are printed on a sheet 20. FIG. 5 also shows more of the details of the inked areas such as 28 and 30, for example a tachometer dial face 44, a speedometer dial face 46, a fuel gauge dial face 48, a temperature gauge dial face 50, and various warning and indicator graphics such as shown at 52. Sheet 20 is die-cut into separate sheets, as shown at 20a, 20b, 20c, 20d, FIG. 6, before or after a deformation forming step is performed on area 32, to be described. FIG. 7 is an enlarged view of one of the appliqués of FIGS. 5, 6.

Areas such as 32 of the substrate are then deformed, preferably with a forming tool 60, FIG. 8, having a male or convex curvature protrusion 62. Alternatively, a concave curvature recess may be provided in forming tool 60 for deforming substrate sheet 20. In the preferred embodiment, a thermal forming process is used with high air pressure, known in the art as a Niebling process. Other processes may also be used for deforming substrate sheet 20, including vacuum forming, other high air pressure forming, matched metal tool forming, hydro-forming, various types of bladder type forming, and others. In the preferred embodiment, the appliqué substrate sheet is heated to a level below its glass transition temperature, e.g. about 300° F. (Fahrenheit) for polycarbonate, and an aluminum forming tool with male feature 62 is used to create the relief in the appliqué substrate sheet, to be described. The heated appliqué substrate sheet is positioned over the tool 60, and the tool is driven upwardly, FIG. 9, into the appliqué substrate sheet 20 while at the same time an air pressure chamber is brought down over the appliqué and sealed to the sheet, and high air pressure is introduced, forcing the appliqué substrate sheet into contact with the tool below it. The heated appliqué substrate sheet responsive to the high air pressure takes on the shape of the tool. Approximately 80 Bar air pressure is preferred. It is preferred that high temperature resistant inks be used for printing areas 28, 30, and 34 if used. The graphics in area 34 may be pre-distorted to assume a correct appearance after forming. The printing inks may further need to be flexible to tolerate forming and some stretching, particularly if area 32 is printed for tinting purposes or the like. In alternate embodiments, area 32 is printed on its first and/or second surface for color contrast, tinting, or a different color transparency, e.g. for back-lit applications.

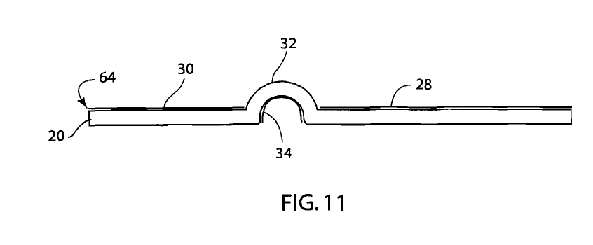

FIG. 10 shows the formed appliqué 36 provided by sheet 20 having a printed first area 28, 30 provided a printed graphic, and a deformed second area 32 having a relief profile providing a three dimensional formed graphic which may be printed or not. FIG. 11 shows a graphic 64 formed from the substrate of FIG. 3, with printed ink at 34. In preferred form, the height of the relief at 32 as shown at dashed line 33 in FIG. 10 is about 0.125 inch above printed areas 28, 30.

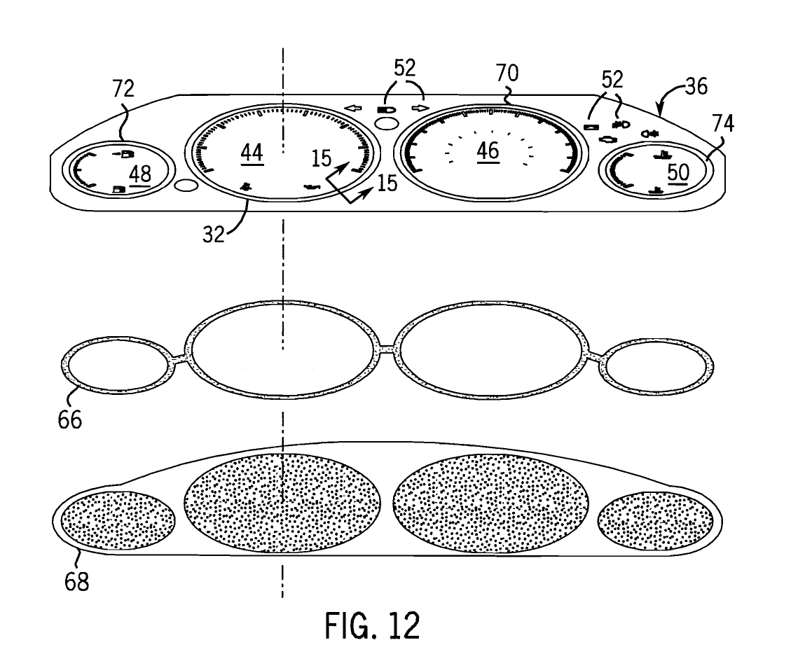

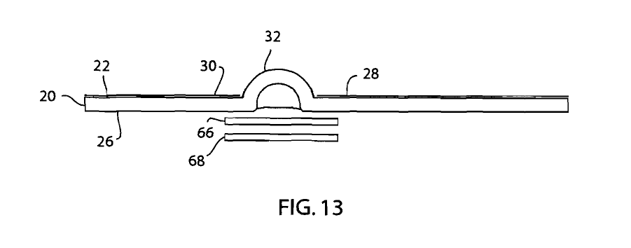

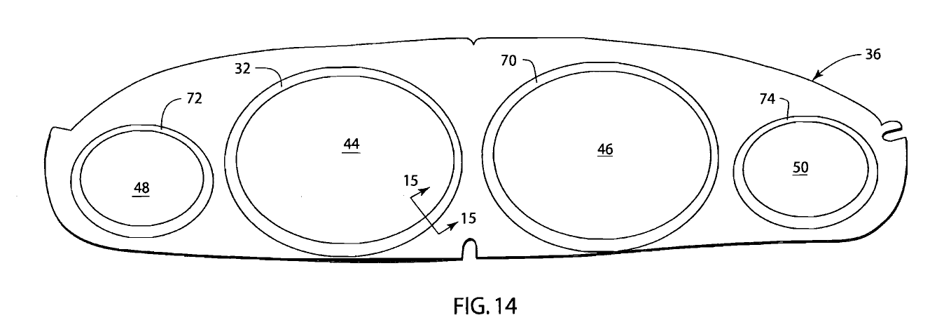

One or more insert layers such as 66, FIGS. 12, 13, may be provided beneath the appliqué, rearward of second surface 26 and behind three dimensional formed graphic 32. Insert 66 may provide a color for viewing through area 32, and/or may be transparent and pass light therethrough from a back light to area 32. Additionally, or alternatively, an EL (electroluminescent lamp) layer 68, or other light source or layer, may be provided rearward of second surface 26 behind three dimensional formed graphic 32 for emitting light forwardly through insert layer 66, if present, and through area 32. In one application, insert layer 66 is a transparent or see-through chrome material to provide chrome-appearing three dimensional formed graphic 32 raised above substrate sheet 20, which chrome appearance is provided by reflection from layer 66 and/or transmission of light therethrough from EL layer 68. This latter implementation is desirable in automotive applications to provide three dimensional formed graphic raised chrome rings 32, 70, 72, 74, FIG. 14, around respective dials or gauges 44, 46, 48, 50. For simplicity of drawing, the dial face printing and marking indicia have been deleted from FIG. 14.

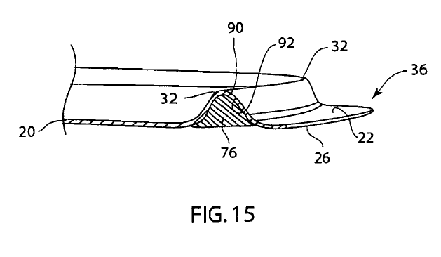

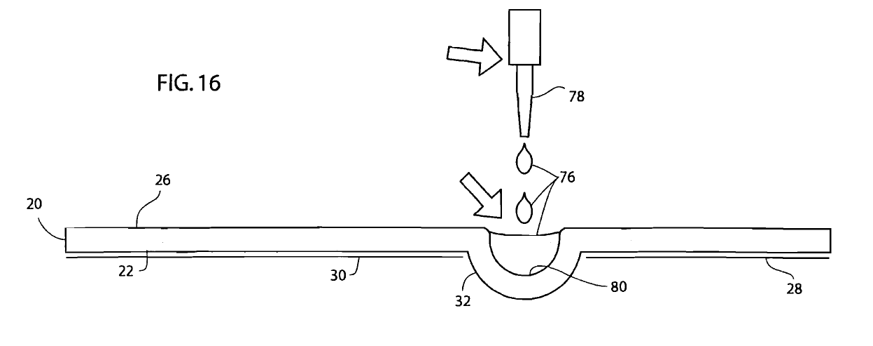

FIG. 15 shows a perspective view, partly in section, of a portion of the appliqué of FIG. 12, and of FIG. 14 prior to inclusion of layers 66 and 68, and shows a further embodiment including a liquid filling 76, FIG. 16, to be described. Substrate sheet 20 is inverted, FIG. 16, and liquid fill material, preferably urethane resin 76, is dispensed from nozzle 78 into the concave recess 80 in the relief profile at area 32, to at least partially fill recess 80. The liquid conforms to the concave curvature of recess 80. The liquid is then cured, preferably by infrared heating, to solidify the liquid to a lens bending light rays passing therethrough to provide a lens at the three dimensional formed graphic at 32, and also at 70, 72, 74. Liquid resin 76 may include a pigment for coloration. The liquid resin and/or the pigment may include particles providing a glitter effect.

Appliqué 36 is provided by sheet 20 having a printed first area such as 28, 30 providing a printed graphic, such as 44, 46, 48, 50, and a deformed second area such as 32 having a relief profile providing a three dimensional formed graphic bordering the printed graphic. The three dimensional formed graphic 32 at least partially frames printed graphic 44. In one form, three dimensional formed graphic 32 is a continuous closed-loop ring surrounding and circumscribing printed graphic 44. Three dimensional formed graphics 70, 72, 74 are likewise continuous closed-loop rings surrounding and circumscribing respective printed graphics 46, 48, 50.

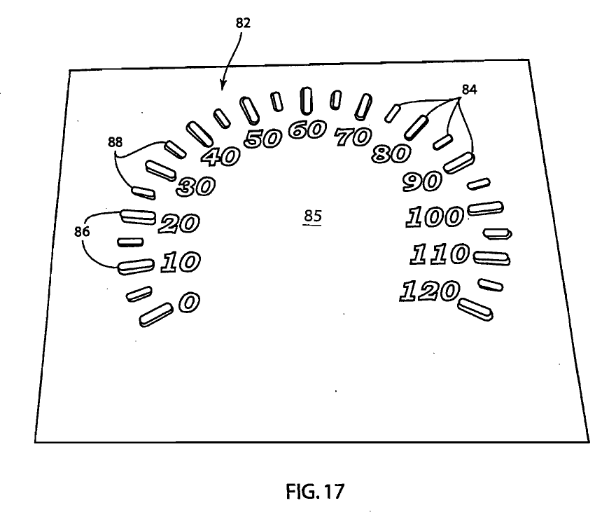

In an alternate embodiment, FIG. 17, the three dimensional formed graphic 82 is provided by a plurality of discreet segments 84 framing printed graphic 86, e.g. a speedometer dial face. Segments 84 include a first set of segments 86 of a first size, and a second set of segments 88 of a second smaller size, preferably of lower height than segments 86, e.g. to provide on a speedometer dial face a more prominent three dimensional formed graphic at 86 at multiples of ten miles per hour, and a less prominent lower height formed graphic at 88 at five mile per hour increments between the noted dominant ten mile per hour increments. The first and second sets 86 and 88 are interdigitated such that segments of the first set 86 having the larger size are spaced by respective segments of the second set 88 having the smaller size. Such segments may completely or partially frame printed graphic dial face 86.

In the embodiments noted above, the noted second area 32, 70, 72, 74, 86, 88 of sheet 20 is deformed forwardly toward observer 24 such that first surface 22 has a convex curvature protrusion 90, FIG. 15, providing the noted three dimensional formed graphic, and second surface 26 has a concave curvature recess 92 at the noted three dimensional formed graphic. Sheet 20 is preferably transparent at least one of the first surface convex curvature protrusion 90 and the second surface concave curvature recess 92. In further embodiments, at least one of the first surface 22 at area 32 and second surface 26 at area 32 is tinted. Sheet 20, including at deformed area 32 at the noted three dimensional formed graphic between first surface convex curvature protrusion 90 and second surface concave curvature recess 92, has a thickness in the noted range 0.005 inch to 0.06 inch, and further preferably about 0.02 inch. An insert layer 66 may be provided rearward of second surface 26 behind the noted three dimensional formed graphic. An EL (electroluminescent lamp) layer 68 may be provided rearward of second surface 26 and behind the noted three dimensional formed graphic. In one embodiment, a transparent chrome insert layer 66 is provided between EL layer 68 and second surface 26 at the three dimensional formed graphic. The three dimensional formed graphic has a height 33 at the noted second area above the printed first area 28, 30 at least two times the thickness of sheet 20, and preferably in the range of 2 to 25 times greater than such thickness including at deformed area 32 at the three dimensional formed graphic between first surface convex curvature protrusion 90 and second surface concave curvature recess 92. Second surface concave curvature recess 92 at recess 80 is at least partially filled with a liquid 76 conforming to the noted concave curvature and solidified to a lens bending light rays passing therethrough to provide a lens at the three dimensional formed graphic bordering the noted printed graphic. The three dimensional formed graphic lens 76 at least partially frames the printed graphic with a lens frame.

It is recognized that various equivalents, alternatives and modifications are possible within the scope of the appended claims.

1-32. (canceled)

33. An appliqué comprising a sheet having a printed first area providing a printed graphic, and a deformed second area having a relief profile providing a three dimensional formed graphic bordering said printed graphic, wherein said three dimensional formed graphic at least partially frames said printed graphic, and wherein said three dimensional formed graphic comprises a plurality of discreet segments framing said printed graphic.

34. The appliqué according to claim 33 wherein said segments comprise a first set of segments of a first size and a second set of segments of a second size, said first and second sizes being different.

35. The appliqué according to claim 34 wherein said first and second sets are interdigitated such that segments of said first set having said first size are spaced by respective segments of said second set having said second size.

36. The appliqué according to claim 33 wherein said segments comprise a first set of segments of a first height above said printed area, and a second set of segments of a second height above said printed area, said first and second heights being different, said first and second sets being interdigitated such that said segments of said first set having said first height are spaced by respective segments of said second set having said second height.

37. An appliqué comprising a sheet having a printed first area providing a printed graphic, and a deformed second area having a relief profile providing a three dimensional formed graphic bordering said printed graphic, wherein said three dimensional formed graphic at at least partially frames said printed graphic, wherein said appliqué has a first surface facing forwardly toward an observer, and an oppositely facing second surface facing rearwardly away from said observer, and wherein said second area of said sheet is deformed forwardly toward said observer such that said first surface has a convex curvature protrusion providing said three dimensional formed graphic, and said second surface has a concave curvature recess at said three dimensional formed graphic, and comprising an insert layer rearward of said second surface and behind said three dimensional formed graphic.

38. An appliqué comprising a sheet having a printed first area providing a printed graphic, and a deformed second area having a relief profile providing a three dimensional formed graphic bordering said printed graphic, wherein said three dimensional formed graphic at least partially frames said printed graphic, wherein said appliqué has a first surface facing forwardly toward an observer, and an oppositely facing second surface facing rearwardly away from said observer, and wherein said second area of said sheet is deformed forwardly toward said observer such that said first surface has a convex curvature protrusion providing said three dimensional formed graphic, and said second surface has a concave curvature recess at said three dimensional formed graphic, and comprising an EL (electroluminescent lamp) layer rearward of said second surface and behind said three dimensional formed graphic.

39. The appliqué according to claim 38 comprising a transparent chrome insert layer between said EL layer and said second surface at said three dimensional formed graphic.

40. An appliqué comprising a sheet having a printed first area providing a printed graphic, and a deformed second area having a relief profile providing a three dimensional formed graphic bordering said printed graphic, wherein said appliqué has a first surface facing forwardly toward an observer, and an oppositely facing second surface facing rearwardly away from said observer, and wherein said second area of said sheet is deformed forwardly toward said observer such that said first surface has a convex curvature protrusion providing said three dimensional formed graphic, and said second surface has a concave curvature recess at said three dimensional formed graphic, and wherein said second surface concave curvature recess is at least partially filled with a liquid conforming to said concave curvature and solidified to a lens bending light rays passing therethrough to provide a lens at said three dimensional formed graphic bordering said printed graphic.

41. The appliqué according to claim 40 wherein said liquid includes a pigment.

42. The appliqué according to claim 40 wherein said liquid includes particles providing a glitter effect.

43. The appliqué according to claim 40 wherein said three dimensional formed graphic lens at least partially frames said printed graphic with a lens frame.
